(19) United States
(12) Patent Application Publication
(10) Pub. No.: US 2022/0415219 A1
(43) Pub. Date: Dec. 29, 2022

(54) ROTATING DISPLAY APPARATUS USING SEMICONDUCTOR LIGHT-EMITTING DEVICE

(71) Applicant: LG ELECTRONICS INC., Seoul (KR)

(72) Inventors: Sungwhan LEE, Seoul (KR); Jaewoon LEE, Seoul (KR)

(73) Assignee: LG ELECTRONICS INC., Seoul (KR)

(21) Appl. No.: 17/756,473

(22) PCT Filed: Dec. 3, 2019
(86) PCT No.: PCT/KR2019/016900

§ 371 Date: May 25, 2022

(30) Foreign Application Priority Data
Nov. 27, 2019 (KR) 10-2019-0154669

(51) Int. Cl. G09F 11/02; G09F 9/33

(52) U.S. Cl. CPC G09F 11/025; G09F 9/33

(57) ABSTRACT

The present disclosure is applicable to a display apparatus-related technical field, and relates to, for example, a rotating display apparatus using a light-emitting diode (LED) which is a semiconductor light-emitting device. A rotating display apparatus using a light-emitting device, of the present disclosure, comprises: a stationary part including a motor; a rotary part located on the stationary part and rotated by the motor; and a light source module which is coupled to the rotary part, and which includes at least one panel that is radially arranged or at least one panel that is arranged along a cylindrical surface, and a light-emitting device array having individual pixels arranged on each panel in the longitudinal direction, wherein some individual pixels of the light-emitting device array arranged on one panel can have an offset in the direction perpendicular to the longitudinal direction.

### TECHNICAL FIELD

The present disclosure is applicable to display-device-related technical fields, and relates to a rotating display device using a light-emitting diode (LED), which is a semiconductor light-emitting element.

### BACKGROUND ART

Recently, in the field of display technology, display devices having excellent characteristics, such as thinness and flexibility, have been developed. Meanwhile, currently commercialized major displays are represented by a liquid crystal display (LCD) and an organic light-emitting diode (OLED).

However, the LCD has problems in which the response time is slow and it is difficult to realize flexibility, and the OLED has problems in which the lifespan thereof is short and the production yield thereof is low.

Meanwhile, a light-emitting diode (LED), which is a well-known semiconductor light-emitting element that converts current into light, has been used as a light source for displaying an image in electronic devices including information communication devices together with a GaP:N-based green LED, starting with commercialization of a red LED using a GaAsP compound semiconductor in 1962. Therefore, a method of solving the above-described problems by implementing a display using the semiconductor light-emitting element may be proposed. Such a light-emitting diode has various advantages, such as a long lifespan, low power consumption, excellent initial driving characteristics, and high vibration resistance, compared to a filament-based light-emitting element.

Meanwhile, when a light source module in which light-emitting elements are arranged in one dimension is rotated and driven at a high speed according to the angle thereof, various letters, graphics, and videos may be recognized by a human due to an after-image effect.

In general, when still images are continuously displayed at a rate of 24 or more sheets per second, a viewer recognizes the same as a video. A conventional image display device, such as a CRT, an LCD, or a PDP, displays still images at a rate of 30 to 60 frames per second, so a viewer is capable of recognizing the same as a video. As the number of still images displayed per second increases, a viewer may experience smoother video, and as the number of still images displayed per second decreases, it becomes difficult to implement smooth video.

In a rotating after-image display device, an emission area varies depending on the sizes and arrangement of sub-pixels, and a non-emission period is necessary in order to prevent crosstalk between adjacent pixels.

That is, in the rotating after-image display device, the sizes of the sub-pixels in the direction of rotation with respect to the size of the pixel vary depending on the method of arranging the sub-pixels, and this variation may cause a difference in the actual light emission time, leading to a reduction in the maximum brightness (luminance) of the display.

Accordingly, there may be a limitation on the depth to which luminance can be expressed, and because space for wiring is necessary when light sources are disposed in one direction, there may be a limitation on the extent to which resolution can be increased.

In order to drive light-emitting elements, a large number of drivers may be required. The drivers may be embodied as a driver IC. One driver is capable of driving several light-emitting elements.

With the realization of high-resolution displays, it is required to dispose a great number of light sources. For example, a light-emitting element array provided on the light source module of a rotary-type after-image display device, may include a great number of light-emitting elements in order to realize a high-resolution display.

Meanwhile, because there is a limitation on the number of light-emitting elements capable of being driven by a single driver, there is need for a larger number of drivers.

Because a large number of drivers each having a certain size are mounted on a light source module, the width of the light source module has to be increased. A light source module having increased width causes deterioration of transmissivity when used in a rotary-type display. Furthermore, because a large number of drivers are used, manufacturing time and costs may increase.

Accordingly, there is a need to provide a solution for reducing the number of drivers and thus improving transmissivity and for reducing manufacturing time and costs while realizing a high-resolution display.

### DISCLOSURE

### Technical Task

A technical task of the present disclosure is to provide a rotary-type display device using a semiconductor light-emitting element, which is capable of reducing the number of drivers while realizing a high-resolution display.

Another technical task of the present disclosure is to provide a rotary-type display device using a semiconductor light-emitting element, which is capable of improving transmissivity and reducing manufacturing time and costs.

### Technical Solutions

In a first aspect for accomplishing the above tasks, the present disclosure provides a rotary-type display device using a light-emitting element including a fixed portion including a motor, a rotary portion positioned on the fixed portion and rotated by the motor, and a light source module comprising at least one panel coupled to the rotary portion and radially disposed or disposed along a circular cylindrical surface and a light-emitting element array including a plurality of pixels disposed on the panel in a longitudinal direction, wherein some of the plurality of pixels of the light-emitting array disposed at the at least one panel are offset in a direction perpendicular to the longitudinal direction.

The pixels that are offset and the pixels that are not offset may be driven at different times.

The different times may be dependent on the rotational speed of the rotary portion.

The plurality of pixels disposed on the panel may be alternately disposed at a first location and a second location.

The light source module may include a plurality of drivers configured to drive the light-emitting element array, one of the plurality of drivers being configured to drive individual pixels disposed at the first location and individual pixels disposed at the second location.

Among the plurality of pixels, even pixels may be disposed at the first location, and odd pixels may be disposed at the second location.

The plurality of pixels of the light-emitting element array disposed at the at least one panel may include a first pixel group disposed at the first location, and a second pixel group disposed at the second location, the offset being formed between the first location and the second location.

The first pixel group and the second pixel group may be driven at different times at the same location.

In a second aspect for accomplishing the above tasks, the present disclosure provides a rotary-type display device using a light-emitting element including a fixed portion including a motor, a rotary portion positioned on the fixed portion and rotated by the motor, and a light source module comprising at least one panel coupled to the rotary portion and radially disposed or disposed along the circular cylindrical surface thereof and a light-emitting element array including a plurality of pixels disposed on the panel in a longitudinal direction, wherein the plurality of pixels of the light-emitting element array disposed at the at least one panel comprises a first pixel group disposed along a first line and a second pixel group disposed along a second line that is spaced apart from the first line by a predetermined distance, and wherein the first pixel group and the second pixel group are driven at different times at the same location.

The predetermined distance may correspond to an offset in a direction perpendicular to the longitudinal direction.

One driver may sequentially drive the individual pixels disposed at the first location and the individual pixels disposed at the second location, which are located adjacent to the one driver.

Among the plurality of pixels, even pixels may be disposed at the first location, and odd pixels may be disposed at the second location.

The light source module may include a driver, configured to drive the light source array, and an image processor, configured to transmit a control signal to the driver to simultaneously drive the first pixel group and the second pixel group at different times.

### Advantageous Effects

An embodiment of the present disclosure conveys the following effects.

First, according to the present disclosure, by classifying pixels and then driving them in this manner, it is possible to reduce the number of drivers and thus improve transmissivity and to reduce manufacturing time and costs while realizing a high-resolution display.

Furthermore, it is possible to realize smooth video without the occurrence of an offset in the actual display between pixels driven at different times.

Furthermore, the present disclosure conveys additional technical effects that have not been mentioned herein, and these effects will be understood by those skilled in the art from the entire matter of the specification and the accompanying drawings.

### DESCRIPTION OF DRAWINGS

FIG. 1 is a perspective view illustrating a rotary-type display device according to a first embodiment of the present disclosure;

FIG. 2 is a perspective view illustrating a rotary-type display device according to a second embodiment of the present disclosure;

FIG. 3 is a perspective view showing the front surface of a light source module according to the present disclosure;

FIG. 4 is a perspective view showing the rear surface of the light source module according to the present disclosure;

FIG. 5 is an enlarged view of portion A in FIG. 3;

FIG. 6 is a cross-sectional view of the light source module according to the present disclosure;

FIG. 7 is a block diagram of the rotary-type display device according to the present disclosure;

FIG. 8 is a plan view illustrating a rotary-type display device according to a second embodiment of the present disclosure;

FIG. 9 is a plan view illustrating the front surface of a portion of a light source module according to the second embodiment of the present disclosure;

FIG. 10 is a plan view illustrating the rear surface of a portion of the light source module according to the second embodiment of the present disclosure;

FIG. 11 is a schematic view illustrating an example of arrangement of pixels of the rotary-type display device;

FIG. 12 is a view illustrating a light emission pattern and a light emission time according to the arrangement of pixels;

FIG. 13 is a schematic view illustrating a time-division process according to an embodiment of the present disclosure;

FIG. 14 is a view illustrating a light emission pattern and a light emission time according to the arrangement of the pixels shown in FIG. 13;

FIG. 15 is a view illustrating an embodiment of arrangement of the pixels of the light source module;

FIG. 16 is a view illustrating a light emission pattern in time-division driving according to the arrangement of the pixels;

FIG. 17 is a view illustrating the arrangement of pixels of the light source module according to an embodiment of the present disclosure;

FIG. 18 is a view illustrating a light emission pattern in a time-division driving according to the arrangement of the pixels shown in FIG. 17;

FIG. 19 is a schematic view illustrating a time-division driving process according to another embodiment of the present disclosure;

FIG. 20 is a view illustrating a light emission pattern and a light emission time according to the arrangement of the pixels shown in FIG. 19;

FIG. 21 is a graph representing an example of an offset angle according to an embodiment of the present disclosure; and

FIG. 22 is a graph representing an example of an offset angle according to another embodiment of the present disclosure.

### BEST MODE FOR DISCLOSURE

Reference will now be made in detail to embodiments of the present disclosure, examples of which are illustrated in the accompanying drawings. Wherever possible, the same reference numbers will be used throughout the drawings to refer to the same or like parts, and a redundant description thereof will be omitted. As used herein, the suffixes “module” and “unit” are added or used interchangeably to facilitate preparation of this specification, and are not intended to suggest distinct meanings or functions. In describing embodiments disclosed in this specification, relevant well-known technologies may not be described in detail in order to avoid obscuring the subject matter of the embodiments disclosed in this specification. In addition, it should be noted that the accompanying drawings are only for easy understanding of the embodiments disclosed in the present specification, and should not be construed as limiting the technical spirit disclosed in the present specification.

Furthermore, although the drawings are separately described for simplicity, embodiments implemented by combining two or more drawings are also within the scope of the present disclosure.

In addition, when an element such as a layer, a region, or a substrate is described as being “on” another element, it is to be understood that the element may be directly on the other element, or there may be an intermediate element between them.

The display device described herein conceptually includes all display devices that display information with a unit pixel or a set of unit pixels. Therefore, the term “display device” may be applied not only to finished products but also to parts. For example, a panel corresponding to a part of a digital TV also independently corresponds to the display device in the present specification. Such finished products include a mobile phone, a smartphone, a laptop computer, a digital broadcasting terminal, a personal digital assistant (PDA), a portable multimedia player (PMP), a navigation system, a slate PC, a tablet PC, an Ultrabook, a digital TV, a desktop computer, and the like.

However, it will be readily apparent to those skilled in the art that the configuration according to the embodiments described herein is also applicable to new products to be developed later as display devices.

In addition, the term “semiconductor light-emitting element” mentioned in this specification conceptually includes an LED, a micro LED, and the like, and may be used interchangeably therewith.

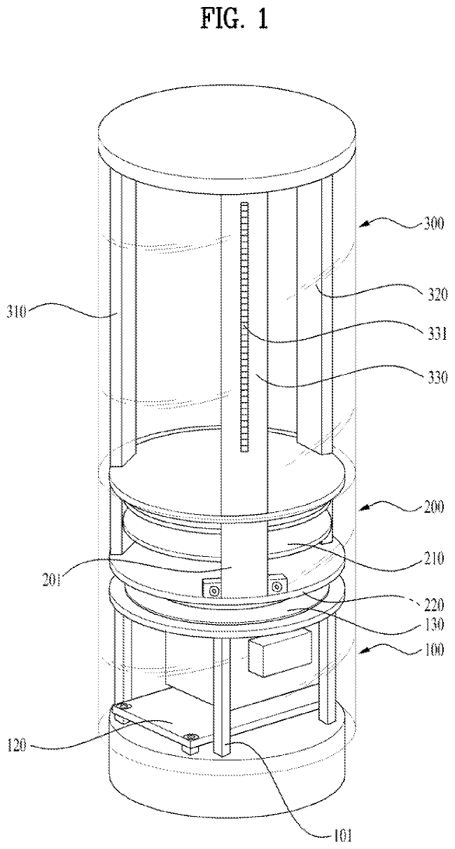

FIG. 1 is a perspective view illustrating a rotary-type display device according to a first embodiment of the present disclosure.

FIG. 1 illustrates a cylindrical rotary-type display device in which light-emitting element arrays 311 are respectively and longitudinally provided at one or more panels 310, 320 and 333 disposed along the circumferential surface of the rotary-type display device. In FIG. 1, only the light-emitting element array 311 that is provided at the front panel 330 is viewable. Although the light-emitting element arrays provided at the left panel 310 and the right panel 320 are not shown in the drawing, light-emitting element arrays each having the same structure may also be applied to the left panel 310 and the right panel 320.

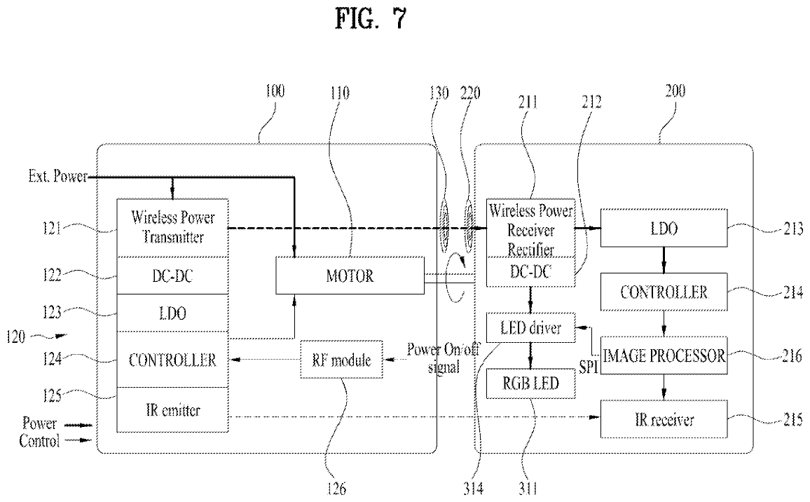

Broadly speaking, the rotary-type display device may include a fixed portion 100 including a motor 110 (see FIG. 7), a rotary portion 200, which is positioned on the fixed portion 100 and is rotated by the motor 110, and a light source module 300, which is coupled to the rotary portion 200 and includes the light-emitting element arrays 311 mounted on the panel 310, 320, and 330 (hereinafter, referred to as “first panels”) to embody a display configured to display an after-image by rotation thereof.

Here, the light source module 300 may include the light-emitting element arrays 311, which are respectively and longitudinally mounted on the one of more bar-shaped first panels 310, 320 and 330, which are disposed on the cylindrical outer circumferential surface at regular intervals.

In FIG. 1, the light source module 300 may include three first panels 310, 320 and 330, each of which includes the light-emitting element array 311 (hereinafter, referred to as a “first light-emitting element array”). However, this embodiment is only one example, and the light source module 300 may include one or more panels.

The first light-emitting element array 311 may be constructed such that pixels are longitudinally arranged on each of the first panels 310, 320 and 330. Here, sub-pixels constituting each of the pixels may be arranged in a direction perpendicular to the longitudinal direction. Furthermore, the sub-pixels constituting each of the pixels may be arranged in a direction parallel to the longitudinal direction.

The sub-pixels of each of the pixels may sequentially emit light in the pixel.

A detailed description of the first light-emitting element array 311 included in the light source module 300 will be given later.

The first panels 310, 320 and 330, which constitutes the light source module 300, may be embodied as printed circuit boards (PCBs). In other words, each of the first panels 310, 320 and 330 may have the function of a printed circuit board. The light-emitting array of each of the first panels 310, 320 and 330 may constitute a unit pixel and may be arranged in the longitudinal direction of the panel.

The panel equipped with the light-emitting element array may be rotated so as to realize a display using an after-image. Realization of the after-image will be described in detail later.

Although the light source module 300 may be constituted by a plurality of first panels 310, 320 and 330, as described above, the light source module 300 may also be constituted by a single panel equipped with a light-emitting array. When the light source module 300 is constituted by a plurality of panels, as shown in FIG. 1, a plurality of sub-images, which are allocated to the plurality of panels, may realize one single frame image. Accordingly, the light source module 300 may be rotated at a rotational speed lower than in the case in which the same frame is realized by a single panel.

The fixed portion 100 may constitute a frame structure. In other words, the fixed portion 100 may include a plurality of frames 101, which are designed to be coupled to each other so as to constitute the fixed portion 100.

The frame structure may provide a space in which the motor 110 is mounted and a space in which a power supply 120, an RF module 126 (see FIG. 7), and the like are mounted.

Furthermore, the fixed portion 100 may be provided with a weight (not shown) configured to reduce the influence of high-speed rotation of the rotary portion 200.

Similar to the fixed portion 100, the rotary portion 200 may also constitute a frame structure. In other words, the rotary portion 200 may include a plurality of frames 201, which are designed to be coupled to each other to constitute the rotary portion 200.

The frame structure may provide a space in which a drive circuit 210 configured to drive the first light-emitting array 311 to realize a display is mounted.

The driving shaft of the motor 110 may be fixed to a shaft-fixing portion (not shown) formed at the frames 201 of the rotary portion 200. As a result, the driving shaft of the motor 110 may be positioned coaxially with the rotational center of the rotary portion 200.

The light source module 300 may be fixed to the upper sides of the frames 201.

Power may be transmitted between the fixed portion 100 and the rotary portion 200 via wireless power transmission. To this end, a transmission coil 130 may be mounted on the upper side of the fixed portion 100 so as to transmit power in a wireless manner, and a receiving coil 220 may be mounted on the lower side of the rotary portion 200 at a position that faces the transmission coil 130.

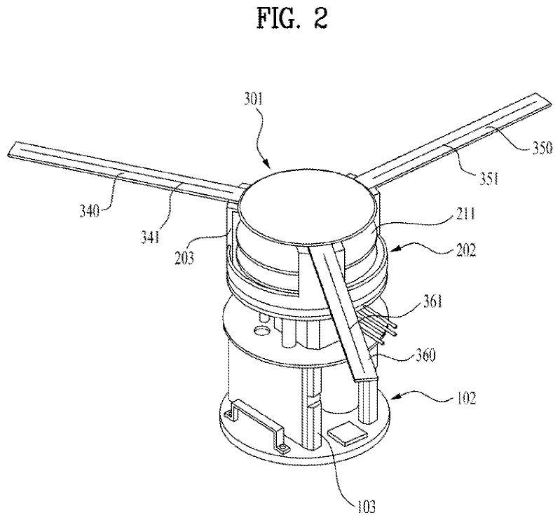

FIG. 2 is a perspective view illustrating a rotary-type display device according to a second embodiment of the present disclosure.

FIG. 2 illustrates a rotary-type display device in which light-emitting element arrays 341, 351, and 361 (hereinafter, referred to as a second light-emitting element arrays) are provided at respective blade panels 340, 350 and 360 (hereinafter, referred to as second panels) in the longitudinal directions of the respective panels.

Broadly speaking, the rotary display device may include a fixed portion 102 including a motor 110 (see FIG. 7), a rotary portion 202, which is positioned on the fixed portion 102 and is rotated by a motor 110, and a light source module 301, which includes second light-emitting element arrays 341, 351, and 361 and displays an after-image to realize a display by rotation thereof.

As illustrated in the drawing, the light source module 301 may include one or more second bar-shaped panels 340, 350 and 360, which are radially disposed about the rotational center thereof, and the second light-emitting element arrays 341, 351, and 361, which are respectively disposed on the second panels 340, 350 and 360 in the respective longitudinal directions thereof.

In this way, the light source module 301 may be composed of the second panels 340, 350, and 360 on which the second light-emitting element arrays 341, 351, and 361 are respectively arranged.

Although the light source module 301 may be composed of a plurality of second panels 340, 350 and 360, the light source module 301 may also be composed of a single panel on which a light-emitting element array is disposed. When the light source module 301 is constituted as a plurality of panels, as shown in FIG. 2, a plurality of sub-images, which are allocated to the plurality of panels, may realize one single frame image. Accordingly, the light source module 301 may be rotated at a rotational speed lower than the case in which the same frame is realized by a single panel.

Individual pixels may be longitudinally disposed in each of the second light-emitting element arrays 341, 251 and 361 of the second panels 340, 350 and 360. The sub-pixels constituting each of the pixels may be arranged in a direction perpendicular to the longitudinal direction. Meanwhile, the sub-pixels constituting each of the pixels may be arranged in a direction parallel to the longitudinal direction.

A concrete description of the second light-emitting element arrays 341, 351, and 361 provided in the light source module 301 will be made in detail later.

The fixed portion 102 may constitute a frame structure. In other words, the fixed portion 102 may include a plurality of frames 103, which are designed to be coupled to each other to constitute the fixed portion 102.

The frame structure may provide a space, in which the motor 110 is mounted, and a space in which the power supply 120, the RF module 126 (see FIG. 7), and the like are mounted.

Furthermore, the fixed portion 102 may be provided with a weight (not shown) configured to reduce the influence of high-speed rotation of the rotary portion 202.

Similarly to the fixed portion 102, the rotary portion 202 may also constitute a frame structure. In other words, the rotary portion 202 may include a plurality of frames 203, which are designed to be coupled to each other to constitute the rotary portion 202.

The frame structure may provide a space in which the drive circuit 210 configured to drive the second light-emitting arrays 341, 351, and 361 to realize a display, is mounted.

The driving shaft of the motor 110 may be fixed to a shaft-fixing portion (not shown) formed at the frames 203 of the rotary portion 202. As a result, the driving shaft of the motor 110 may be positioned coaxially with the rotational center of the rotary portion 202.

The light source module 301 may be fixed to the upper sides of the frames 201.

Although the second embodiment of the present disclosure has been described heretofore with reference to FIG. 2, the second embodiment may be substantially identical to the first embodiment, with the exception of the difference in the configuration of the light source module 301. Accordingly, the configuration of the first embodiment may be similarly applied to components of the second embodiment that have not been described herein.

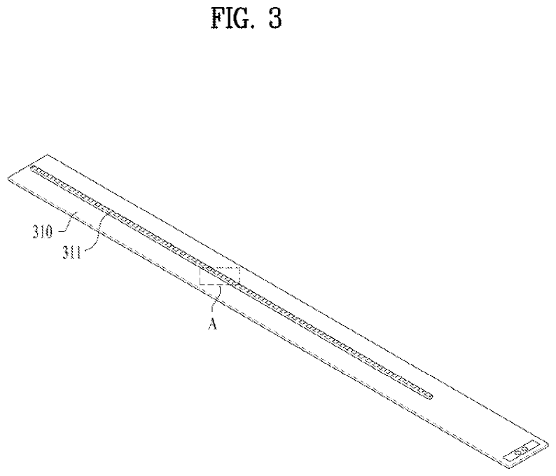

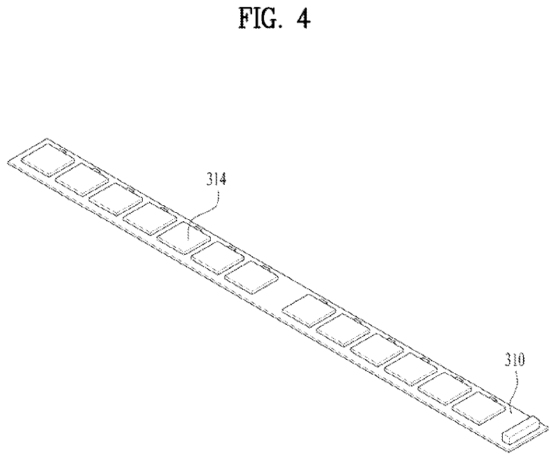

FIG. 3 is a perspective view showing the front surface of a light source module according to the first embodiment of the present disclosure, and FIG. 4 is a perspective view showing the rear surface of the light source module according to the first embodiment of the present disclosure.

Although FIGS. 3 and 4 illustrate the first panel 310 of the first embodiment as an example, the configuration illustrated in FIGS. 3 and 4 may be identically applied not only to the other panels 320 and 330 but also to the panels 340, 350, and 360 of the second embodiment. That is, the light source module of the first embodiment and the light source module of the second embodiment may have the same configuration.

In other words, each of the first light-emitting element arrays 311 and each of the second light-emitting element arrays 341, 351, and 361 may have the same structure. Hereinafter, the light source module will be described based on the first light-emitting element array 311.

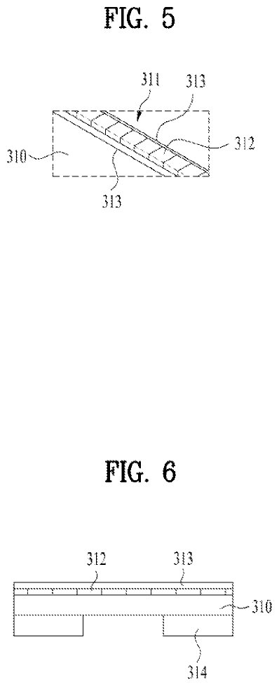

FIG. 3 illustrates one panel 310 forming the light source module 300. As mentioned above, the panel 310 may be a printed circuit board (PCB). A plurality of light-emitting elements 312 (refer to FIG. 5) may be mounted on the panel 310 so as to be disposed in one direction to form pixels, thereby constituting the light-emitting element array 311. Here, a light-emitting diode (LED) may be used as the light-emitting element.

That is, the light-emitting elements 312 are disposed in one direction on one panel 310 to form individual pixels, with the result that the light-emitting element array 311 may be provided so as to be linearly mounted.

FIG. 4 illustrates the rear surface of the panel 310. Drivers 314 for driving the light-emitting elements 312 may be mounted on the rear surface of the panel 310, which constitutes the light source module.

Since the drivers 314 are mounted on the rear surface of the panel 310, as described above, the drivers 314 may not interfere with a light-emitting surface, the influence on light emission from the light sources (the light-emitting elements) 312 due to interference may be minimized, and the area of the panel 310 may be minimized. The panel 310, having a small area, may improve the transparency of the display.

Meanwhile, the front surface of the panel 310, on which the light-emitting element array 311 is mounted, may be processed into a dark color (e.g. black) in order to improve the contrast ratio and the color expression of the display, thereby maximizing the effect of the light sources.

FIG. 5 is an enlarged view of portion A in FIG. 3, and FIG. 6 is a cross-sectional view of the light source module according to the present disclosure.

Referring to FIG. 5, it can be seen that the individual light-emitting elements 312 are mounted linearly in one direction (the longitudinal direction of the panel). In this case, a protective portion 313 may be located outside the light-emitting elements 312 in order to protect the light-emitting elements 312.

Red, green, and blue light-emitting elements 312 may form one pixel in order to realize natural colors, and the individual pixels may be mounted in one direction on the panel 310.

Referring to FIG. 6, the light-emitting elements 312 may be protected by the protective portion 313. Further, as described above, the drivers 314 may be mounted on the rear surface of the panel 310, and may drive the light-emitting elements 312 in units of pixels or sub-pixels. In this case, one driver 314 may individually drive at least one pixel.

FIG. 7 is a block diagram of the rotary-type display device according to the present disclosure.

Hereinafter, a configuration for driving the rotary-type display device will be described briefly with reference to FIG. 7. Although this configuration will be described with reference to the first embodiment described above, the same may also be identically applied to the second embodiment.

First, a driving circuit 210 may be mounted to the fixed portion 100. The driving circuit 120 may include a power supply. The driving circuit 120 may include a wireless power transmitter 121, a DC-DC converter 122, and a voltage generator 123 for supplying individual voltages.

External power may be supplied to the driving circuit 120 and the motor 110.

In addition, an RF module 126 may be provided at the fixed portion 100, so that the display may be driven in response to a signal transmitted from the outside.

Meanwhile, a means for sensing rotation of the rotary portion 200 may be provided at the fixed portion 100. Infrared radiation may be used to sense rotation. Accordingly, an IR emitter 125 may be mounted to the fixed portion 100, and an IR receiver 215 may be mounted to the rotary portion 200 at a position corresponding to the IR emitter 125.

In addition, a controller 124 may be provided at the fixed portion 100 in order to control the driving circuit 120, the motor 110, the IR emitter 125, and the RF module 126.

Meanwhile, the rotary portion 200 may include a wireless power receiver 211 for receiving a signal from the wireless power transmitter 121, a DC-DC converter 212, and a voltage generator (LDO) 213 for supplying individual voltages.

The rotary portion 200 may be provided with an image processor 216 in order to realize an image through the light-emitting element array using RGB data of an image to be displayed. The signal processed by the image processor 216 may be transmitted to the drivers 314 of the light source module, and thus an image may be realized.

In addition, a controller 214 may be mounted to the rotary portion 200 in order to control the wireless power receiver 211, the DC-DC converter 212, the voltage generator (LDO) 213, the IR receiver 215, and the image processor 216.

The image processor 216 may generate a signal for controlling light emission from the light sources of the light source module based on data of an image to be output. At this time, the data for light emission from the light source module may be internal data or external data.

The data stored in the internal device (the rotary portion 200) may be image data pre-stored in a storage device, such as a memory (an SD-card) mounted together with the image processor 216. The image processor 216 may generate a light emission control signal based on the internal data.

The image processor 216 may transmit control signals to the drivers 314 so that the first light-emitting element arrays 311 and the second light-emitting element arrays 341, 351, and 361 display image data of a specific frame in a delayed manner.

Meanwhile, the image processor 216 may receive image data from the fixed portion 100. At this time, external data may be output through an optical data transmission device, such as a photo coupler, or an RF-type data transmission device, such as a Bluetooth or Wi-Fi device.

In this case, as mentioned above, a means for sensing rotation of the rotary portion 200 may be provided. That is, the IR emitter 125 and the IR receiver 215 may be provided as a means for detecting the rotational position (speed) of the rotary portion 200, such as an absolute rotational position or a relative rotational position, in order to output light source data suitable for each rotational position (speed) during rotation of the rotary portion 200. Alternatively, this function may also be achieved using an encoder, a resolver, or a Hall sensor.

Meanwhile, data required to drive the display may be transmitted as a signal in an optical manner at low cost using the principle of a photo coupler. That is, if the fixed portion 100 and the rotary portion 200 are provided with a light emitter and a light receiver, reception of data is continuously possible even when the rotary portion 200 rotates. Here, the IR emitter 125 and the IR receiver 215 described above may be used to transmit data.

As described above, power may be transferred between the fixed portion 100 and the rotary portion 200 in a wireless power transfer (WPT) manner.

Wireless power transfer enables the supply of power without connection of a wire using a resonance phenomenon of a coil.

To this end, the wireless power transmitter 121 may convert power into an RF signal of a specific frequency, and a magnetic field generated by current flowing through the transmission coil 130 may generate an induced current in the reception coil 220.

At this time, the natural frequency of the coil and the transmission frequency for transferring actual energy may differ from each other (a magnetic induction method).

Meanwhile, the resonant frequencies of the transmission coil 130 and the reception coil 220 may be the same (a magnetic resonance method).

The wireless power receiver 211 may convert the RF signal input from the reception coil 220 into direct current, and may transmit required power to a load.

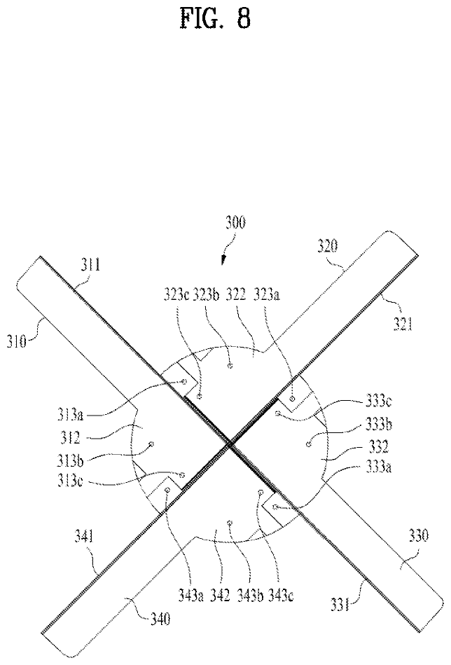

FIG. 8 is a plan view illustrating a rotary-type display device according to a second embodiment of the present disclosure.

FIG. 8 illustrates a rotary-type display device in which the light-emitting element arrays 311, 321, 331, and 341 are longitudinally disposed at respective wing-type panels 310, 320, 330 and 340.

When the light source module 300 includes four panels 310, 320, 330, and 340, as in the embodiment, each of the couplers 312, 322, 332, and 342, which are respectively connected to the four panels 310, 320, 330, and 340, may have a quadrant shape, which is one of four sectors constituting one circle and having ¼ the size of the circle. In other words, each of the couplers 312, 322, 332, and 342 may have two end side that meet at the center of the circle at an angle of 90 degrees. In other words, each of the couplers 312, 322, 332, and 342 may include two end sides, which have an included angle of 90 degrees therebetween. However, the included angle between the two end sides may change depending on the number of the panels. For example, when there are three panels, the included angle between the two end sides may be 120 degrees.

Here, one of the two end sides may be parallel to the light-emitting element array mounted on the associated panel, and the other of the two end sides may be parallel to the light-emitting element array mounted on an adjacent panel.

Specifically, the first panel 310 may be connected to the first coupler 312, and the first light-emitting element array 311 may be provided along the first panel 310 and the first coupler 313. Here, the first coupler 312 may have two end sides, which respectively face two adjacent couplers (for example, the second coupler 322 and the fourth coupler 342). One of the two end sides may be parallel to the first light-emitting element array 311, and the other of the two end sides may be parallel to the fourth light-emitting element array 341 provided at the fourth panel 340.

Consequently, the end sides of the first coupler 312 may not interfere with the light-emitting element array (the fourth light-emitting element array 341) of the adjacent panels (for example, the second panel 320 and the fourth panel 340).

The couplers 312, 322, 332, and 342 may extend from respective panels 310, 320, 330, and 340. In other words, the couplers 312, 322, 332, and 342 may be integrally formed with respective panels 310, 320, 330, and 340.

Referring to FIG. 1, each of the couplers 312, 322, 332, and 342 may have a mount hole configured to allow the associated coupler to be mounted to the upper frame 202 therethrough. For example, the first coupler 312 may have one or more mount holes 313a, 313b, and 313c, through which the first coupler 312 is mounted to the upper frame 202.

Furthermore, the second coupler 322 may have therein one or more mount holes 323a, 323b and 32c, through which the second coupler 322 is mounted to the upper frame 202. Similarly to the second coupler 322, the third coupler 332 may have therein one or more mount holes 333a, 333b, and 333c, through which the third coupler 332 is mounted to the upper frame 202, and the fourth coupler 342 may have therein one or more mount holes 343a, 343b, and 343c, through which the fourth coupler 342 is mounted to the upper frame 202.

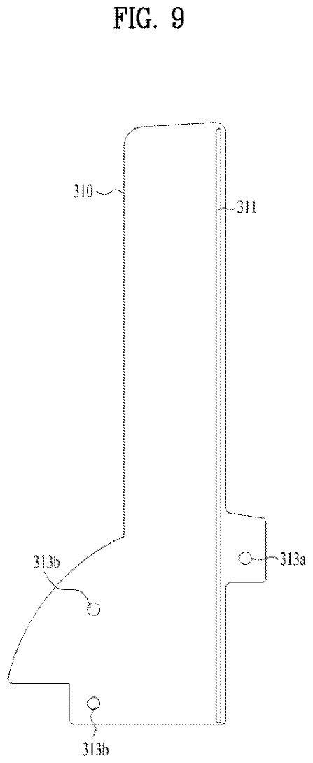

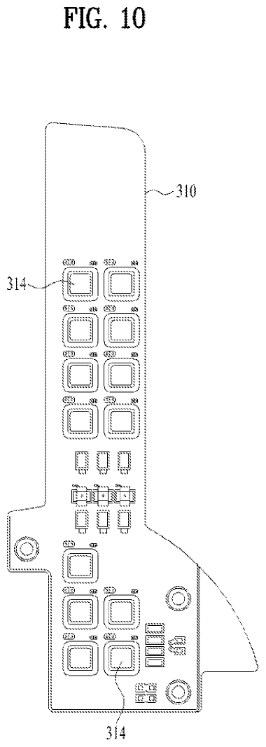

FIG. 9 is a plan view illustrating the front surface of a portion of a light source module according to the second embodiment of the present disclosure. FIG. 10 is a plan view illustrating the rear surface of a portion of the light source module according to the second embodiment of the present disclosure. FIGS. 9 and 10 are plan views, which respectively illustrate the front and rear surfaces of a specific embodiment of the light source module shown in FIGS. 3 and 4.

FIG. 9 illustrates the front surface of the first panel 310 of the light source module shown in FIG. 8. FIG. 10 illustrates the rear surface of the first panel 310 of the light source module shown in FIG. 8.

Similarly to FIG. 4, it will be appreciated from FIG. 10 that a large number of drivers 314 are provided on the rear surface of the first panel 310. Each of the drivers 314 may be embodied as a driver IC. Each of the drivers 314 may drive several light-emitting elements.

Meanwhile, in order to realize a high-resolution display, there is need for a larger number of light sources (light-emitting elements). For example, in order to realize a high-resolution display, the light-emitting element array 311 provided on the first panel 310 may include more light-emitting elements 312 (see FIG. 5).

Because there is a limitation on the number of light-emitting elements capable of being driven by one driver 314, a larger number of drivers 314 are required. As illustrated in FIG. 10, a larger number of drivers 314 may be mounted on the rear surface of the first panel 310.

Accordingly, because a larger number of drivers 314 each having a certain size are mounted, the width of the panel (the first panel) 310 increases. A light source module having increased width may decrease transmissivity when used in a rotary-type display device. In addition, the use of a large number of drivers 314 may increase manufacturing time and costs.

Accordingly, there is need for solution for reducing the number of drivers 314 and thus improving transmissivity and for reducing manufacturing time and costs while realizing a high-resolution display.

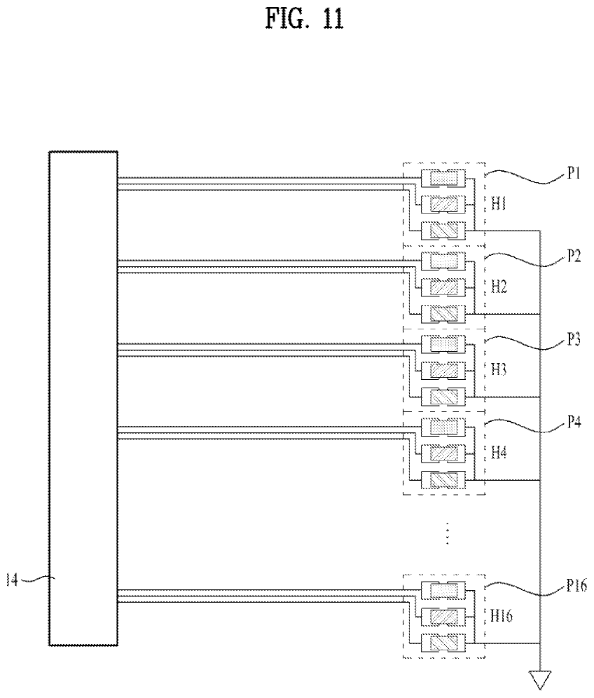

FIG. 11 is a schematic view illustrating an example of arrangement of pixels of the rotary-type display device.

FIG. 11 illustrates a layout of pixels in which sub-pixels are arranged in a vertical direction (that is, in the longitudinal direction of the panel). From this, it will be appreciated that the direction in which the pixels P1, P2, . . . , P16 are arranged is identical to the direction in which the sub-pixels are arranged. Here, one driver 14 is capable of driving a particular number of pixels as a unit. In FIG. 10, the unit number may be 16.

Each of the pixels may have a certain size, that is, a certain width and a certain height, and may include a plurality of sub-pixels configured to represent natural colors. Generally, sub-pixels may include a red (R) sub-pixel, a green (G) sub-pixel, and a blue (B) sub-pixel in order to realize various colors by combining the three primary colors of light.

In FIG. 11, one pixel may include a red (R) sub-pixel, a green (G) sub-pixel, and a blue (B) sub-pixel, which are arranged in that order from above. The sub-pixels are distinctively indicated by shades. Throughout this specification and the attached drawings, the same shade may indicate the same type of sub-pixel among the red (R) sub-pixel, the green (G) sub-pixel, and the blue (B) sub-pixel. Accordingly, numerals indicating the respective colors of the sub-pixels are omitted in the drawings.

Typically, a display device represents an image in a surface form in such a way that a larger number of pixels emit light corresponding to information allocated by individual points. Each of the larger number of points may be a single light source element, which is represented by a pixel, and the pixel may be composed of sub-pixels, such as R, G and B sub-pixels.

A single pixel is typically designed so as to have an aspect ratio of 1:1. To this end, each of the R, G and B sub-pixels may have a rectangular shape.

The rectangular sub-pixels may be arranged in various fashions according to a design purpose.

Because the realism of an image viewed by the human eye increases when the number of pixels per inch (PPI) of the image increases, a display having a high PPI is required. In order to realize a display having a high PPI, the size of a pixel may be reduced. The size of a pixel cannot be equal to or smaller than the total size of the R, G and B sub-pixels constituting the light source.

In a traditional display, the size of sub-pixels, which are arranged in a fashion different from that proposed herein, is equal to the size of an actual light-emitting region. However, because the positions of sub-pixels vary over time in the rotary-type display device according to the present disclosure, which uses the after-image phenomenon, the actual light-emitting area varies in accordance with the following Equation 1.

Size of sub-pixel in direction tangential to direction of rotation(crosswise direction)×Moving time <Equation 1>

Due to this characteristic of an after-image display, mixing of colors with adjacent pixels may occur. Accordingly, a rotary-type display device requires a non-lighting zone in order to prevent color mixing between pixels.

The non-lighting zone, which is required to prevent mixing of color, corresponds to the length of a sub-pixel in a rotational direction.

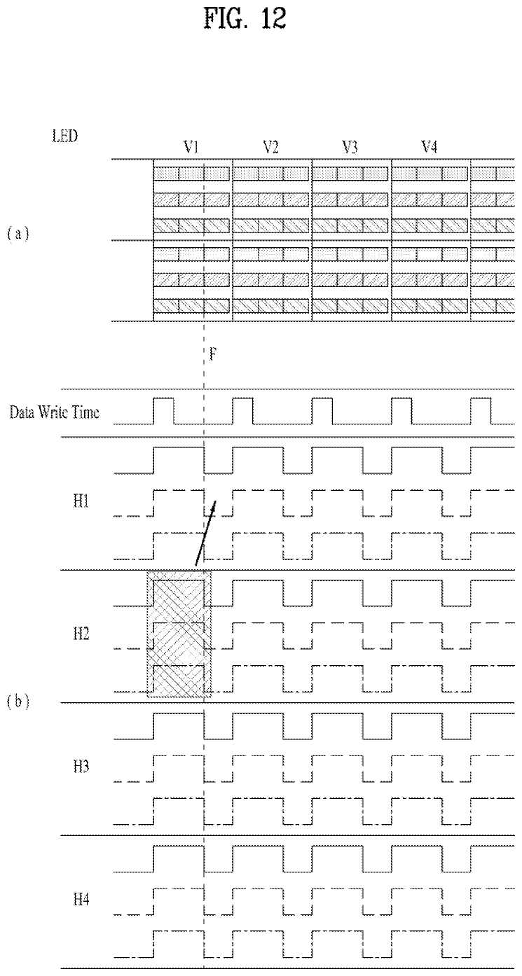

FIG. 12 is a view illustrating a light emission pattern and a light emission time according to the arrangement of pixels.

FIG. 12(a) illustrates a light emission pattern according to the arrangement of the pixels shown in FIG. 11, and FIG. 12(b) illustrates a light emission time according to the arrangement of the pixels shown in FIG. 11.

Lighting and non-lighting of a sub-pixel may be repeatedly performed when the associated pixel moves to locations V1, V2, V3 and V4 due to rotation. Here, the lighting may be performed for a relatively long period of time in a relatively wide range.

Consequently, the smaller the ratio of the size of a pixel to the size of a sub-pixel, the shorter the time of actual lighting. This means that, for a given size of light source, the higher the PPI of a display (the smaller the size of a pixel), the shorter the actual lighting time (the lower the brightness of the display).

However, if the size of a sub-pixel, which actually lights, is reduced by improving the arrangement or the driving manner of the light source without reducing the size of the light source (LED), the time of lighting of the pixel may be increased. As a result, the brightness of the display may be increased.

If an LED having the same size is used and restrictions on circuit configuration are the same, there may be an effect of improving the brightness and the PPI when the sub-pixels are individually driven.

Therefore, the present disclosure is intended to provide a rotary-type display device capable of improving brightness and PPI by considering and applying the case in which sub-pixels are individually driven.

When sub-pixels are individually driven in this way in realization of a rotary-type after-image display, an observer who views the display may perceive sub-pixels (R, G and B) at different locations to be located in a single pixel space.

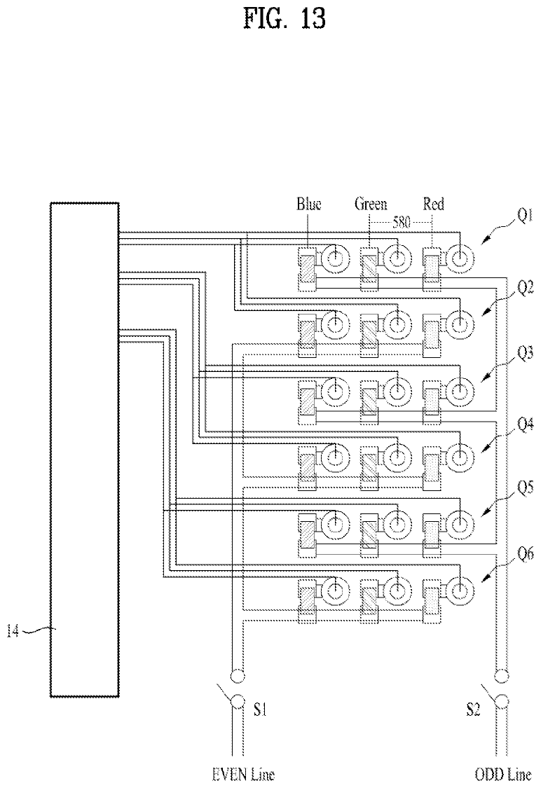

FIG. 13 is a schematic view illustrating a time-division process according to an embodiment of the present disclosure.

FIG. 13 illustrates the layout of pixels in which sub-pixels are arranged in a horizontal direction (that is, in a direction perpendicular to the longitudinal direction of the panel). In other words, it will be appreciated that the direction in which the pixels (Q1, Q2, . . . , Q16) are arranged is perpendicular to the direction in which the sub-pixels are arranged. Here, the driver 14 may drive a unit number of pixels.

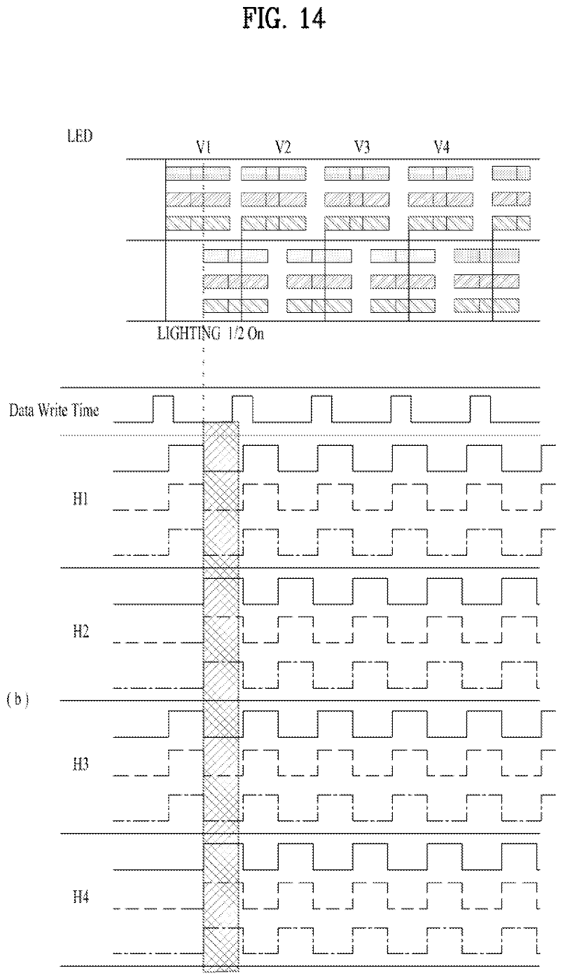

FIG. 14 is a view illustrating a light emission pattern and a light emission time according to the arrangement of the pixels shown in FIG. 13.

FIG. 14(a) illustrates a light emission pattern according to the arrangement of the pixels shown in FIG. 13, and FIG. 12(b) illustrates a light emission time according to the arrangement of the pixels shown in FIG. 13.

Lighting and non-lighting of a sub-pixel may be repeatedly performed when the associated pixel moves to locations V1, V2, V3 and V4 due to rotation. Here, the lighting may be performed for a relatively long period of time in a relatively wide range.

According to the present disclosure, the sub-pixels may be individually driven so as to sequentially emit light in a certain pixel area. As a result, the limitation on physical location between the sub-pixels may be overcome. In other words, there is no need for the sub-pixels to be located in the certain pixel area.

That is, the distance between the sub-pixels may be greater than the distance between sub-pixels in the case in which the sub-pixels simultaneously emit light. Specifically, the sub-pixels may be located so as to be spaced apart from each other by the distance allowed by the after-image of the rotary-type after-image display.

In practice, because a rotary-type display device displays one frame while a light source module is rotated through one revolution, the restriction on the distance between the sub-pixels may be negligible. Consequently, brightness may be improved. Furthermore, because the sub-pixels may be more closely disposed without having to be disposed close to each other, for example, at a location to which the sub-pixels are moved in a parallel direction, it is possible to improve the accuracy.

Furthermore, because the sub-pixels are individually driven, the sub-pixels may be located in different pixel spaces. Consequently, it is possible to ensure a large area for circuit wiring and mounting of a light source.

Accordingly, it is possible to individually drive the sub-pixels by controlling the time between the sub-pixels in consideration of the rotational speed using a rotational after-image. As a result, an observer may perceive the sub-pixels to be located in a single pixel space.

Referring to FIG. 13, for example, the sub-pixels may be classified into odd pixels (sub-pixels; Q1, Q3, Q5 and the like) and even pixels (sub-pixels; Q2, Q4, Q6 and the like), which are driven at different times.

Specifically, the odd pixels (the sub-pixels; Q1, Q3, Q5 and the like) may be connected to a first switch S2, and may be driven at a first time, and the even pixels (the sub-pixels; Q2, Q4, Q6 and the like) may be connected to a second switch S1, and may be driven at a second time.

Here, the odd pixels may be referred to as a first pixel group, and the even pixels may be referred to as a second pixel group. In other words, the first pixel group and the second pixel group may be driven at different times.

However, when this driving process is used, an offset may occur between actual pixels, which are realized by an after-image, as indicated in the upper drawing of FIG. 14.

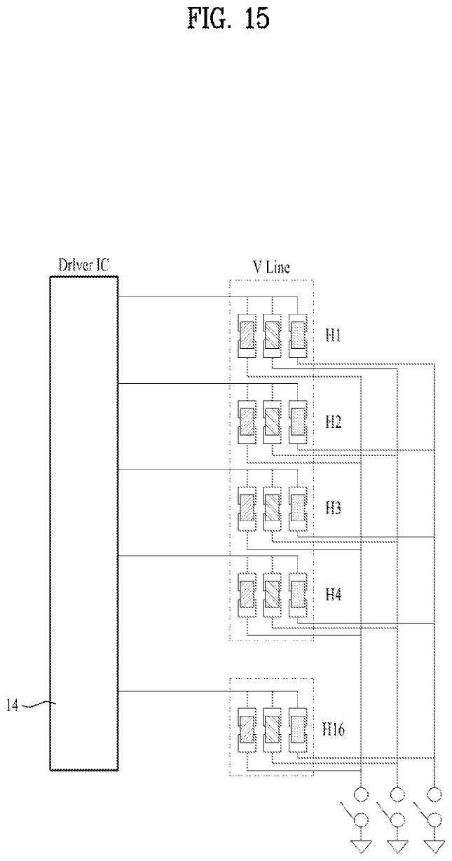

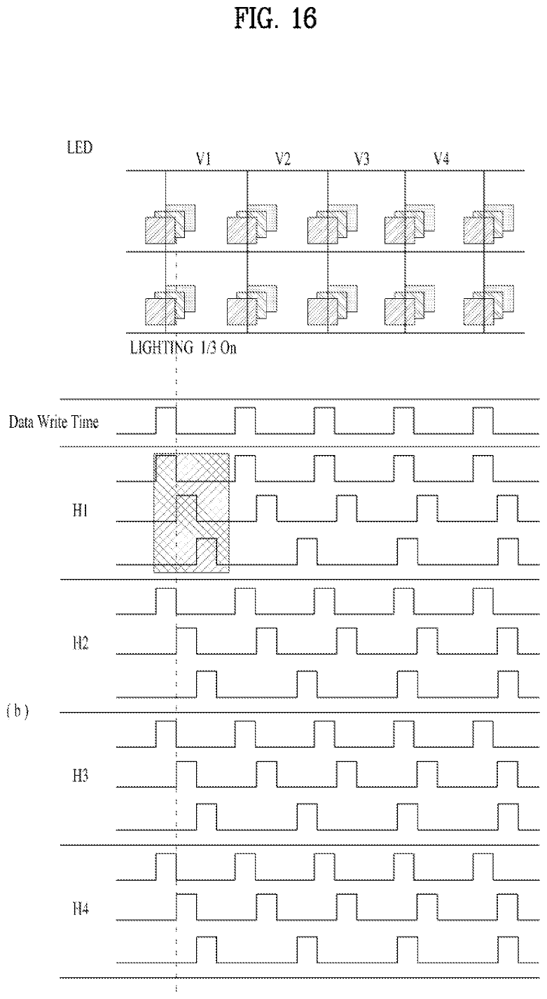

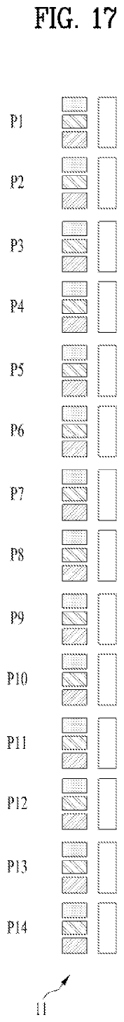

FIG. 15 is a view illustrating an embodiment of arrangement of the pixels of the light source module. FIG. 16 is a view illustrating a light emission pattern in time-division driving according to the arrangement of the pixels.

Hereinafter, the light emission pattern in time-division driving will be described in detail with reference to FIGS. 15 and 16.

Referring to FIG. 15, the pixels P1 to P14, which constitute the light-emitting element array 11, may be arranged in one direction.

In other words, the odd pixels P1, P3, P5 etc. may be driven at a first time, and the even pixels P2, P4, P6 and so on may be driven at a second time.

Here, the odd pixels may be referred to as a first pixel group, and the even pixels may be referred to as a second pixel group. In other words, the first pixel group and the second pixel group may be driven at different times.

However, when this driving process is used, an offset may occur between actual pixels realized by an after-image, as indicated in the upper drawing of FIG. 16.

In other words, the location at which the pixels of the rotary-type display device are displayed may move due to the difference between the driving times.

When the pixels are classified and driven in this manner, it is possible to reduce the number of drivers and thus improve transmissivity and to reduce manufacturing time and costs while realizing a high-resolution display.

However, an offset may occur between actual driving screen areas of the first and second pixel groups, which may deteriorate the resulting screen image, as illustrated in FIG. 16,

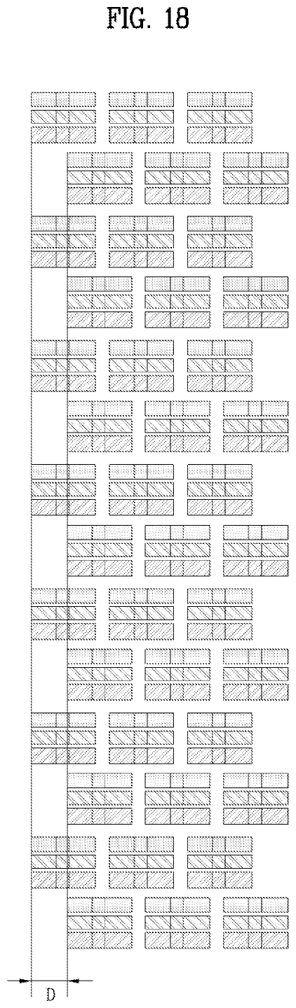

FIG. 17 is a view illustrating the arrangement of pixels of the light source module according to an embodiment of the present disclosure. FIG. 18 is a view illustrating a light emission pattern in a time-division driving according to the arrangement of the pixels shown in FIG. 17.

Hereinafter, the light emission pattern in time-division driving will be described in detail with reference to FIGS. 17 and 18.

Referring to FIG. 17, some of the pixels S1 to S14, which are disposed at one panel (for example, the first panel 310) so as to constitute the light-emitting element array 311, may have an offset D in a direction perpendicular to the longitudinal direction of the panel 310.

For example, the individual pixels S1 to S14 may be alternately disposed at a first location L1 and a second location L2. In other words, the even pixels S2, S4, S6 and the like (311a) may be disposed at the first location L1, and the odd pixels S1, S3, S5 and the like (311b) may be disposed at the second location L2.

The driver 314 may drive the individual pixels disposed at the first location L1 and the second location L2. For example, one driver 314 may drive an even pixel S2 and an adjacent odd pixel S1 at different times.

Furthermore, the driver 314 may drive the even pixel S2 and the adjacent odd pixel S1 at different times in order to perform lighting at the same location.

Specifically, although the driver 314 drives the even pixel S2 and the adjacent odd pixel S1 at different times, the offset D corresponding to the difference between the times may be provided at the first location L1 and the second location L2 such that the individual pixels emit light at the same location on the rotary-type display device, as illustrated in FIG. 18.

As such, the individual pixels of the light-emitting element array 311, which is disposed at one panel 310, may include a first pixel group 311a, which is disposed at the first location L1, and a second pixel group 311b, which is disposed at the second location L2, which is spaced apart from the first location L1 by the offset D.

The first pixel group 311a and the second pixel group 311b may be driven at different times so as to display an actual pixel at the same location. Consequently, the offset on the screen, which has been mentioned above, does not occur.

The time and the offset in driving may be set according to the size of an actual pixel, the rotational speed of the display, and the like. In other words, the offset D provided between the first pixel group 311a and the second pixel group 311b may be set in consideration of the number of panels, the rotational speed of the panels, the difference between times in time-division driving, and the like.

When the pixels are classified and driven in this way, it is possible to reduce the number of drivers and thus improve transmissivity and to reduce manufacturing time and costs while realizing a high-resolution display.

Furthermore, an offset between pixels driven at different times does not occur in an actual display, thereby realizing smooth video.

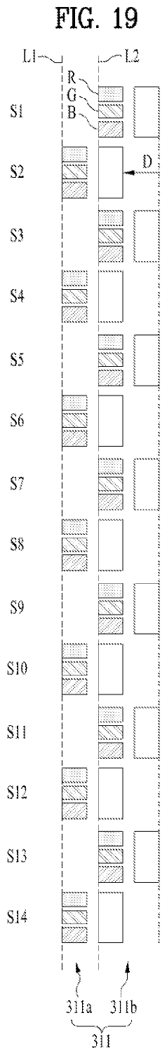

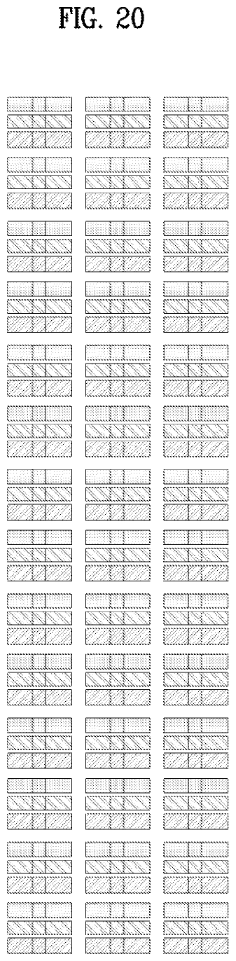

FIG. 19 is a schematic view illustrating a time-division driving process according to another embodiment of the present disclosure. FIG. 20 is a view illustrating a light emission pattern and a light emission time according to the arrangement of the pixels shown in FIG. 19.

FIG. 20(a) illustrates a light emission pattern according to the arrangement of the pixels shown in FIG. 19, and FIG. 20(b) illustrates a light emission time according to the arrangement of the pixels shown in FIG. 19.

Referring to FIG. 19, sub-pixels may be classified into red sub-pixels, green sub-pixels, and blue sub-pixels, and the red sub-pixels, the green sub-pixels, and the blue sub-pixels may be driven at different times.

In other words, the red sub-pixels, the green sub-pixels, and the blue sub-pixels may be connected to different switches, and may be driven at different times.

Here, the red sub-pixels may be referred to as a first pixel group, the green sub-pixels may be referred to as a second pixel group, and the blue sub-pixels may be referred to as a third pixel group. In other words, the first pixel group, the second pixel group, and the third pixel group may be driven at different times.

Although additionally illustrated in the drawings, the first pixel group, the second pixel group, and the third pixel group may be constructed such that the locations of the pixels are set so as to have a certain offset capable of compensating for the different times, as described above. The description given with reference to FIGS. 17 and 18 may be similarly applied to this embodiment.

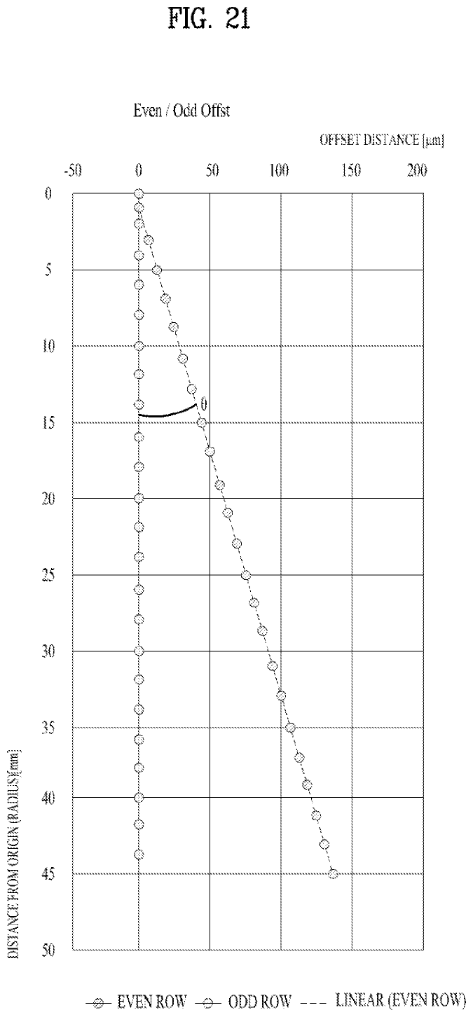

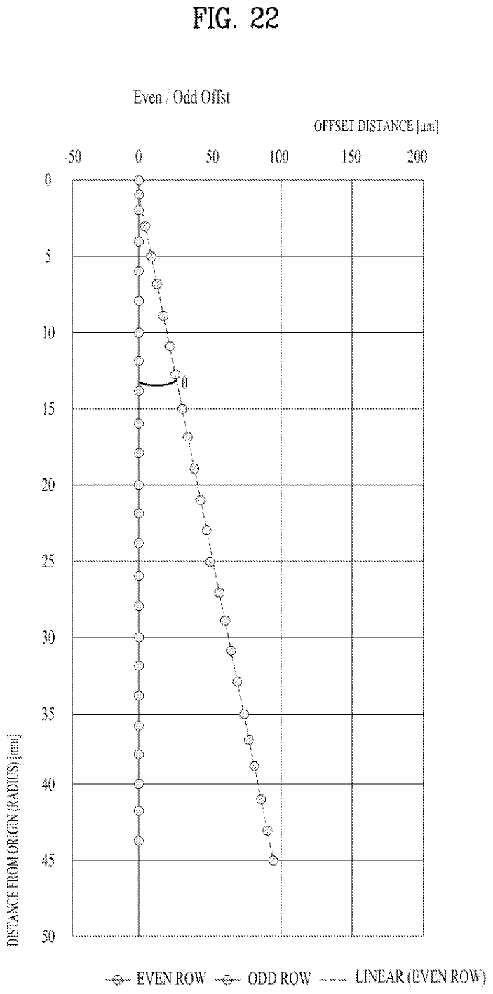

FIG. 21 is a graph representing an example of an offset angle according to an embodiment of the present disclosure. FIG. 22 is a graph representing an example of an offset angle according to another embodiment of the present disclosure.

FIG. 21 illustrates an example of an offset angle of a bisected circular display including 1024 pixels.

In such a case of 1023 pixels and a bisected display, the offset between an even pixel (even) and an odd pixel (odd) may be represented as the angle (0) about the rotational center.

Here, when the offset is indicated by a length, the offset may be represented as “r*sin θ”. In this way, the offset may be appropriately plotted on the graph according to a driving process, a specific configuration of the display, or the like, and the specific value thereof may be omitted.

In the case of a trisected display including 1024 pixels shown in FIG. 22, the offset between the even pixel (even) and the odd pixel (odd) may be represented as the angle (θ) about the rotational center.

Similarly to the case shown in FIG. 21, when the offset is indicated by a length, the offset may be represented as “r*sin θ”.

The above description is merely illustrative of the technical spirit of the present disclosure. It will be apparent to those skilled in the art that various modifications and variations can be made in the present disclosure without departing from the spirit and scope of the disclosure.

Therefore, the embodiments disclosed in the present disclosure are merely illustrative of the technical spirit of the present disclosure. The scope of the technical spirit of the present disclosure is not limited by these embodiments.

The scope of the present disclosure should be construed by the appended claims, and all technical ideas within the scope equivalent thereto should be construed as falling within the scope of the present disclosure.

### INDUSTRIAL APPLICABILITY

According to the present disclosure, it is possible to provide a rotary-type display device using light-emitting diodes (LEDs), which are semiconductor light-emitting elements.

1-15. (canceled)

16. A rotary-type display device using a light-emitting element, the rotary-type display device comprising:
a fixed portion including a motor;
a rotary portion positioned on the fixed portion and rotatable by the motor; and
a light source comprising at least one panel coupled to the rotary portion and disposed radially or along a circular cylindrical surface of the rotary portion, and a light-emitting element array including a plurality of pixels disposed at the at least one panel along a longitudinal direction of the at least one panel,
wherein a portion of the plurality of pixels disposed at the at least one panel have an offset with respect to a direction perpendicular to the longitudinal direction.

17. The rotary-type display device of claim 16, wherein the portion of the plurality of pixels that have the offset and a portion of the plurality of the pixels that do not have the offset are driven at different times.

18. The rotary-type display device of claim 16, wherein the different times are dependent on a rotational speed of the rotary portion.

19. The rotary-type display device of claim 16, wherein the plurality of pixels disposed at the at least one panel are alternately disposed at a first location and a second location.

20. The rotary-type display device of claim 19, wherein the light source further comprises a plurality of drivers configured to drive the light-emitting element array, one of the plurality of drivers being configured to drive individual pixels disposed at the first location and individual pixels disposed at the second location.

21. The rotary-type display device of claim 19, wherein, among the plurality of pixels, even pixels are disposed at the first location, and odd pixels are disposed at the second location.

22. The rotary-type display device of claim 19, wherein the plurality of pixels disposed at the at least one panel comprises:
a first pixel group disposed at the first location; and
a second pixel group disposed at the second location, the offset being defined between the first location and the second location.

23. The rotary-type display device of claim 22, wherein the first pixel group and the second pixel group are driven at different times to emit light at a same location.

24. A rotary-type display device using a light-emitting element, the rotary-type display device comprising:
a fixed portion including a motor;
a rotary portion positioned on the fixed portion and rotatable by the motor; and
a light source comprising at least one panel coupled to the rotary portion and disposed radially or along a circular cylindrical surface of the rotary portion, and a light-emitting element array including a plurality of pixels disposed at the at least one panel along a longitudinal direction of the at least one panel,
wherein the plurality of pixels disposed at the at least one panel comprises a first pixel group disposed along a first linear direction and a second pixel group disposed along a second linear direction that is spaced apart from the first linear direction by a predetermined distance, and
wherein the rotary-type display device is configured to drive the first pixel group and the second pixel group at different times to emit light at a same location.

25. The rotary-type display device of claim 24, wherein the predetermined distance corresponds to an offset with respect to a direction perpendicular to the longitudinal direction.

26. The rotary-type display device of claim 24, wherein the different times are dependent on a rotational speed of the rotary portion.

27. The rotary-type display device of claim 24, wherein the light source further comprises a plurality of drivers configured to drive the light-emitting element array, a first driver of the plurality of drivers being configured to drive individual pixels disposed at a first location and individual pixels disposed at a second location.

28. The rotary-type display device of claim 27, wherein the first driver sequentially drives the individual pixels disposed at the first location and the individual pixels disposed at the second location, which are located adjacent to the first driver.

29. The rotary-type display device of claim 27, wherein, among the plurality of pixels, even pixels are disposed at the first location, and odd pixels are disposed at the second location.

30. The rotary-type display device of claim 24, wherein the light source further comprises:
a driver configured to drive the light-emitting element array; and
an image processor configured to transmit a control signal to the driver to simultaneously drive pixels of the first pixel group at a first time, and to simultaneously drive pixels of the second pixel group at a second time different from the first time.
